(19) United States
(12) Patent Application Publication
(10) Pub. No.: US 2007/0080900 A1
(43) Pub. Date: Apr. 12, 2007

(54) Plasma display device and driving method thereof

(76) Inventors: Joon-Yeon Kim, Yongin-si (KR); Hak-Cheol Yang, Yongin-si (KR); Hyun-Gu Heo, Yongin-si (KR); Jeong-Nam Kim, Yongin-si (KR)

Correspondence Address: CHRISTIE, PARKER & HALE, LLP, PO BOX 7068, PASADENA, CA, 91109-7068, US

(21) Appl. No.: 11/543,706

(22) Filed: Oct. 4, 2006

(30) Foreign Application Priority Data
Oct. 12, 2005 (KR) 10-2005-0095992

(51) Int. Cl. G09G 3/28

(52) U.S. Cl. 345/63

(57) ABSTRACT

A plasma display device includes a plasma display panel including first display regions and second display regions extending in a first direction and first electrodes extending in a second direction crossing the first direction. First cells are defined by the first display regions and the first electrodes, and second cells are defined by the second display regions and the first electrodes. The plasma display device is driven during frames, and each frame is divided into a plurality of subfields. In a first subfield of a first frame, a driver selects at least one on-cell among the first cells and/or the second cells using a first address method. In a second subfield of the first frame, the driver selects at least one off-cell among the first cells and selects at least one off-cell among the second cells, using a second address method.

### CROSS-REFERENCE TO RELATED APPLICATION

This application claims priority to and the benefit of Korean Patent Application No. 10-2005-0095992 filed in the Korean Intellectual Property Office on Oct. 12, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display that uses plasma generated by a gas discharge process to display characters or images. It includes a plurality of discharge cells.

The plasma display device is driven during frames of time. One frame of the plasma display device is divided into a plurality of subfields each having a corresponding brightness weight. On-cells or off-cells are selected among the discharge cells by an address discharge in an address period of each subfield, and the on-cells are sustain-discharged for a sustain period to display an image.

During the address period, scan pulses are applied to display lines for defining the discharge cells in a row direction such that on-cells or off-cells are selected. Therefore, scan circuits respectively corresponding to the display lines are required to apply the scan pulses to the display lines. The scan circuits corresponding to the number of the display lines may increase the production costs of the plasma display device.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a plasma display device for reducing the number of scan circuits, and a driving method thereof.

According to one exemplary embodiment, a plasma display device includes: a plasma display panel including a plurality of first display regions extending in a first direction, a plurality of second display regions extending in the first direction, a plurality of first electrodes extending in a second direction crossing the first direction, a plurality of first cells defined by the plurality of first display regions and the plurality of first electrodes, and a plurality of second cells defined by the plurality of second display regions and the plurality of first electrodes; a controller adapted to drive the plasma display device during frames including a first frame and a second frame, and to divide each frame into a plurality of subfields including a first subfield and a second subfield; and a driver. The driver is adapted to, in the first subfield of the first frame: select at least one on-cell among the plurality of first cells and/or the plurality of second cells, by using a first address method for address-discharging at least one of the cells at off-state to place the at least one of the cells at on-state; and sustain-discharge the at least one on-cell; and in the second subfield of the first frame: select at least one off-cell among the plurality of first cells, by using a second address method for address-discharging at least one of the cells at on-state to place the at least one of the cells at off-state, during a first address period; sustain-discharge at least one of the cells remaining at on-state after the first address period, during a first sustain period following the first address period; select at least one off-cell among the plurality of second cells by using the second address method during a second address period following the first sustain period; and sustain-discharge at least one of the cells remaining at on-state after the second address period, during a second sustain period following the second address period.

According to another exemplary embodiment, a method for driving a plasma display device is provided. The plasma display device includes a plurality of first electrodes extending in a first direction, a plurality of second electrodes extending in the first direction, a plurality of third electrodes extending in a second direction crossing the first direction, a plurality of first cells, and a plurality of second cells, the plasma display device being driven during frames including a first frame and a second frame. The method includes: dividing each frame into a plurality of subfields; and in at least one subfield of the first frame: during a first address period, selecting at least one off-cell among the plurality of first cells, by using an address method for address-discharging at least one of the cells at on-state to place the at least one of the cells at off-state; during a first sustain period following the first address period, sustain-discharging at least one of the cells remaining at on-state after the first address period; during a second address period following the first sustain period, selecting at least one off-cell among the plurality of second cells by using the address method; and during a second sustain period following the second address period, sustain-discharging at least one of the cells remaining at on-state after the second address period, wherein the plurality of second electrodes are divided into at least a first group of the second electrodes and a second group of the second electrodes, wherein the plurality of first cells are defined by a plurality of first display regions extending in the first direction and the plurality of third electrodes, and the plurality of second cells are defined by a plurality of second display regions extending in the first direction and the plurality of third electrodes, wherein each first display region is defined by a corresponding one of the first group of the second electrodes and a corresponding one of a plurality of scan lines, and each second display region is defined by a corresponding one of the second group of the second electrodes and a corresponding one of the plurality of scan lines, and wherein each scan line includes corresponding at least one of the plurality of first electrodes.

According to yet another exemplary embodiment, a method for driving a plasma display device is provided. The plasma display device includes a plurality of first electrodes extending in a first direction, a plurality of second electrodes extending in the first direction, a plurality of third electrodes extending in a second direction crossing the first direction, a plurality of first cells, and a plurality of second cells, the plasma display device being driven during frames including a first frame and a second frame. The method includes: dividing each frame into a plurality of subfields including a first subfield and a second subfield; and in the first subfield of the first frame: during a first reset period, initializing the plurality of first cells; during a first address period, selecting at least one first on-cell among the plurality of first cells, by using an address method for address-discharging at least one of the cells at off-state to place the at least one of the cells at on-state; during a first sustain period, sustain-discharging the at least one first on-cell; during a second reset period, initializing the plurality of second cells; during a second address period, selecting at least one second on-cell among the plurality of second cells by using the address method; and during a second sustain period, sustain-discharging the at least one second on-cell, wherein the plurality of second electrodes are divided into at least a first group of the second electrodes and a second group of the second electrodes, wherein the plurality of first cells are defined by a plurality of first display regions extending in the first direction and the plurality of third electrodes, and the plurality of second cells are defined by a plurality of second display regions extending in the first direction and the plurality of third electrodes, wherein each first display region is defined by a corresponding one of the first group of the second electrodes and a corresponding one of a plurality of scan lines, and each second display region is defined by a corresponding one of the second group of the second electrodes and a corresponding one of the plurality of scan lines, and wherein each scan line includes corresponding at least one of the plurality of first electrodes.

According to yet another exemplary embodiment, a method for driving a plasma display device is provided. The plasma display device includes a plurality of first electrodes, a plurality of second electrodes, a plurality of third electrodes crossing the plurality of first and second electrodes, the plasma display device being driven during frames including a first frame and a second frame. The method includes: dividing each frame into a plurality of subfields; in at leas one subfield of the first frame: during a reset period, initializing a plurality of first cells; during an address period, selecting at least one first on-cell among the plurality of first cells; and during a sustain period, sustain-discharging the at least one first on-cell; in at least one subfield of the second frame: during a reset period, initializing a plurality of second cells; during an address period, selecting at least one second on-cell among the plurality of second cells; and during a sustain period, sustain-discharging the at least one second on-cell, wherein the plurality of second electrodes are divided into at least a first group of the second electrodes and a second group of the second electrodes, wherein the plurality of first cells are defined by a plurality of first display regions and the plurality of address electrodes, and the plurality of second cells are defined by a plurality of second display regions and the plurality of address electrodes, wherein each first display region is defined by a corresponding one of the first group of the second electrodes and a corresponding one of a plurality of scan lines, and each second display region is defined by a corresponding one of the second group of the second electrodes and a corresponding one of the plurality of scan lines, and wherein each scan line includes corresponding at least one of the plurality of first electrodes.

### BRIEF DESCRIPTION OF THE DRAWINGS

FIG. 1 shows a diagram representing a plasma display device according to an exemplary embodiment of the present invention.

FIG. 2 shows an electrode arrangement diagram of a plasma display panel (PDP) according to a first exemplary embodiment of the present invention.

FIG. 3 shows an electrode arrangement diagram of the PDP according to a second exemplary embodiment of the present invention.

FIG. 4 shows a diagram for representing a driving method of the plasma display device according to the exemplary embodiment of the present invention.

FIG. 5 shows a diagram representing driving waveforms applied to first to third subfields SF1 to SF3, among driving waveforms of the plasma display device according to the exemplary embodiment of the present invention.

FIG. 6 shows a diagram representing driving waveforms applied in a fourth subfield SF4 according to the first exemplary embodiment of the present invention.

FIG. 7 shows a diagram representing the driving waveforms applied to the fourth subfield SF4 according to the second exemplary embodiment of the present invention.

FIG. 8 shows a diagram representing the driving waveform applied to a fifth subfield SF5 among the driving waveforms of the plasma display device according to the exemplary embodiment of the present invention.

FIG. 9 shows a diagram representing the driving waveforms for compensating the number of times of sustain discharge generation between the Xodd line cell (or odd cell) and the Xeven line cell (or even cell).

### DETAILED DESCRIPTION

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Wall charges mentioned in the following description mean charges formed and accumulated on a wall (e.g., a dielectric layer) close to an electrode of a discharge cell. The wall charge will be described as being “formed” or “accumulated” on the electrode, although the wall charges do not actually touch the electrodes. Further, a wall voltage means a potential difference formed on the wall of the discharge cell by the wall charges, and a wall voltage of an electrode means a potential created by the wall charges formed on the electrode.

A plasma display device according to an exemplary embodiment of the present invention and a driving method thereof will be described with reference to the figures.

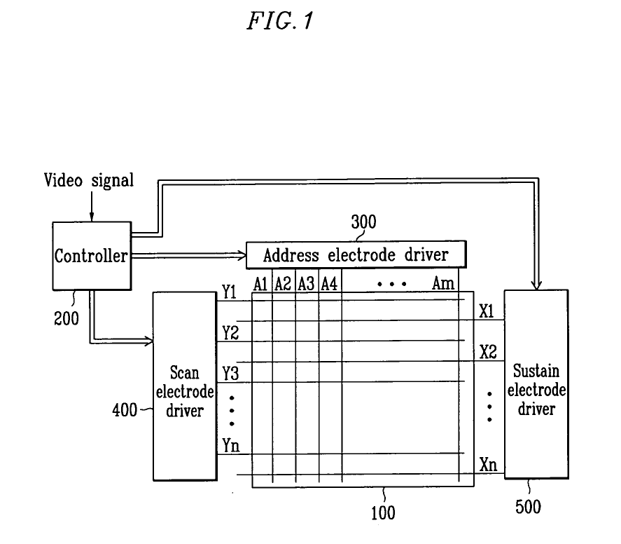

First, the plasma display device according to the exemplary embodiment of the present invention will be described with reference to FIGS. 1, 2 and 3.

FIG. 1 shows a diagram representing the plasma display device according to the exemplary embodiment of the present invention.

As shown in FIG. 1, the plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain and scan electrodes X1 to Xn and Y1 to Yn extending in a row direction in pairs.

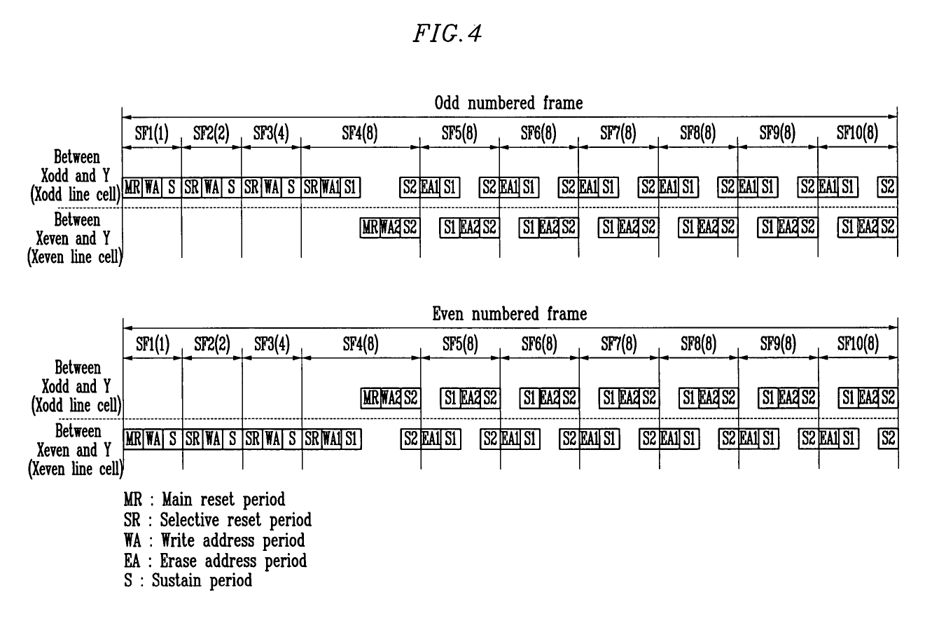

The controller 200 receives an external video signal and outputs an address electrode driving control signal, a sustain electrode driving control signal, and a scan electrode driving control signal. The plasma display device is driven during frames of time. The controller 200 divides each frame into a plurality of subfields respectively having a brightness weight, and drives the plasma display device during the subfields. The controller 200 divides the plurality of X electrodes X1 to Xn into two groups. One of the two groups includes odd-numbered sustain electrodes (Xodd of FIG. 4 to FIG. 9) and the other includes even-numbered sustain electrodes (Xeven of FIG. 4 to FIG. 9).

After receiving the address electrode driving control signal from the controller 200, the address electrode driver 300 applies driving voltages to the respective address electrodes A1-Am.

The scan electrode driver 400 applies driving voltages to the scan electrodes Y after receiving the scan electrode driving control signal from the controller 200, and the sustain electrode driver 500 applies driving voltages to the sustain electrodes X after receiving the sustain electrode driving control signal from the controller 200.

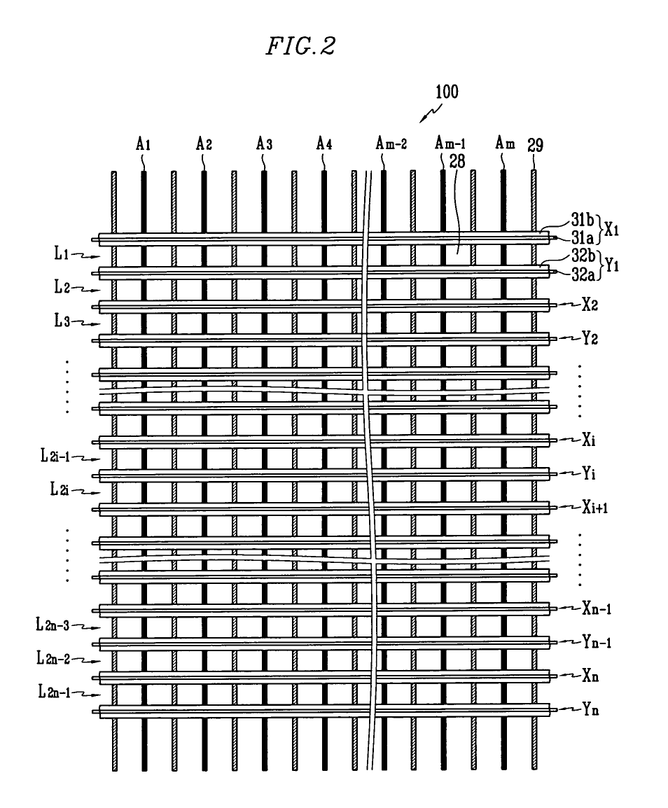

FIG. 2 shows one exemplary embodiment of an electrode arrangement of the PDP shown in FIG. 1.

In the PDP 100 in one embodiment, the address electrodes A1 to Am are formed on one substrate, and the sustain electrodes X1 to Xn and the scan electrodes Y1 to Yn are formed on another substrate, such that the two substrates face each other. As shown in FIG. 2, display regions L1 to L(2n−1) for displaying an image are defined by the scan electrodes Y1 to Yn and the sustain electrodes X1 to Xn, and include first display regions and second display regions. In more detail, each of the first display regions L1, . . . , L(2i−1), . . . , L(2n−1) is defined by a corresponding one of the scan electrodes Y1 to Yn and a corresponding one of the odd-numbered sustain electrodes X1, . . . , Xi, . . . , X(n−1). For convenience, it is assumed in FIGS. 1 to 3 that ‘i’ is an odd number, and ‘n’ is an even number. Each of the second display regions L2, L3, . . . , L2i, . . . , L(2n−2), L(2n−1) is defined by a corresponding one of the scan electrodes Y1 to Yn and a corresponding one of the even-numbered sustain electrodes X2, . . . , X(i+1), . . . , Xn. For example, a display region L1 is defined by a scan electrode Y1 and a sustain electrode X1, and a display region L2 is defined by the scan electrode Y1 and a sustain electrode X2. That is, two adjacent first and second display regions L(2i−1) and L2i share one scan electrode Yi, i.e., one scan line. A scan line is a line for transmitting a scan pulse, and the scan electrodes Y1 to Yn respectively correspond to a plurality of scan lines which are respectively coupled to a plurality of scan circuits.. In addition, each of the scan electrodes Y1 to Yn may be conceptually divided into one portion adjacent to the first display regions (hereinafter referred to as “an odd portion”) and another portion adjacent to the second display region (hereinafter referred to as “an even portion”). That is, the odd portions of the scan electrodes Y1 to Yn are adjacent to the odd-numbered sustain electrodes, and the even portions of the scan electrodes Y1 to Yn are adjacent to the even-numbered sustain electrodes.

Discharge spaces at crossing regions of the display regions L1 to L(2n−1) and the address electrodes A1 to Am respectively define discharge cells (hereinafter referred to as “cells”) 28. The cells 28 are partitioned in the row direction by barrier ribs 29. The barrier ribs 29 extend in the column direction and are provided between two adjacent address electrodes. Each of the sustain electrodes X1 to Xn includes a bus electrode 31a and a transparent electrode 31b, and each of the scan electrodes Y1 to Yn also include a bus electrode 32a and a transparent electrode 32b. The transparent electrodes 31b and 32b are respectively coupled to the bus electrodes 31a and 32a. Here, a portion adjacent to the odd-numbered sustain electrode in the transparent electrode 32b may correspond to the odd portion, and a portion adjacent to the even-numbered sustain electrode in the transparent electrode 32b may correspond to the even portion. In one embodiment, the width (or dimension) along the column direction of the transparent electrode 31b or 32b may be wider than that of the bus electrode 31a or 32a. In one embodiment, the transparent electrode 31b or 32b may be formed by non-transparent materials. In one embodiment, each of the sustain and scan electrodes may be formed by a wide bus electrode without the transparent electrode, or formed by the transparent electrode without the bus electrode. In one embodiment, additional barrier ribs (not shown) may be formed on the bus electrodes 31a and 32a such that the cells 28 may be partitioned in the column direction.

According to the first exemplary embodiment of the present invention, since the two neighboring display regions share one scan electrode or one sustain electrode, the number of sustain and scan electrodes may be reduced compared to a configuration in which only one display region is defined by a pair of the scan and sustain electrodes. For example, when 512 display regions are driven, the number of the sustain or scan electrodes is 512 in a PDP including one sustain electrode and one scan electrode defining one display region. However, in the PDP according to the first exemplary embodiment of the present invention, the number of the sustain or scan electrodes may be about half of 512, i.e., 256. That is, according to the first exemplary embodiment of the present invention, the number of the display regions of the PDP may be doubled while keeping the same number of sustain and scan electrodes as a conventional PDP where electrodes share one display region. Alternatively, the number of the sustain or scan electrodes may be reduced by about half when the PDP is designed with the same resolution as a conventional PDP including the sustain and scan electrodes sharing one display line. In addition, since the two display regions share one scan electrode, i.e., one scan line, the number of scan circuits coupled to the scan electrodes (scan lines) may be reduced by about half.

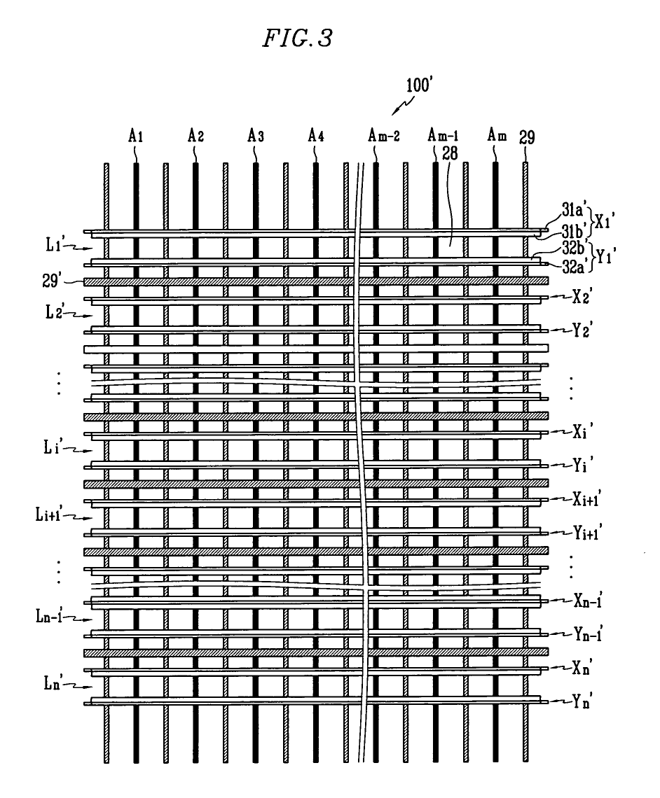

The above PDP configuration is one example, and another configuration applied in another exemplary embodiment of the present invention will now be described. FIG. 3 shows another exemplary embodiment of an electrode arrangement diagram of a PDP 100′. The PDP 100′ may be used in the plasma display device of FIG. 1 instead of the PDP 100.

As shown in FIG. 3, the electrode arrangement of the PDP 100′ according to the second exemplary embodiment of the present invention is similar to that of the first exemplary embodiment of the present invention except that the sustain and scan electrodes share one display region. That is, in the PDP 100′, a barrier rib 29′ is formed between the scan electrode Yi′ and the sustain electrode X(i+1)′. Therefore, the display region Li′ is defined by the sustain electrode Xi′ and the scan electrode Yi′ which is adjacent to the sustain electrode Xi′ at only one side. Therefore, each of a plurality of first display regions L1′, . . . , Li′, . . . , L(n−1)′ is defined by a corresponding one of the odd-numbered sustain electrodes X1′, . . . , Xi′, . . . , X(n−1) and a corresponding one of the odd-numbered scan electrodes Y1′, . . . , Yi′, . . . , Y(n−1)′, and each of a plurality of second display regions L2′, . . . , L(i+1)′, . . . , Ln′ is defined by a corresponding one of the even-numbered sustain electrodes X2′, . . . , X(i+1)′, . . . , Xn′ and a corresponding one of the even-numbered scan electrodes Y2′, . . . , Y(i+1)′, . . . , Yn′. In another embodiment, each of a plurality of first display regions may be defined by a corresponding one of the odd-numbered sustain electrodes and a corresponding one of the even-numbered scan electrodes, and each of a plurality of second display regions is defined by a corresponding one of the even-numbered sustain electrodes and a corresponding one of the odd-numbered scan electrodes. In addition, transparent electrodes 31b′ and 32b′ are formed differently from those of FIG. 2, and are respectively coupled to bus electrodes 31a′ and 32a′.

Furthermore, each of a plurality of scan lines corresponds to a pair of scan electrodes. That is, each scan line includes one of the odd-numbered scan electrodes and one of the even-numbered scan electrodes. Therefore, a scan pulse is concurrently applied to two scan electrodes for an address period. As a result, the number of scan circuits coupled to the scan lines may be reduced by about half.

A method for driving the plasma display device having the PDP according to the first and second exemplary embodiments will now be described. Hereinafter, for convenience of descriptions, the method for driving the plasma display device will be described with reference to the PDP 100 according to the first exemplary embodiment of the present invention shown in FIG. 2. The method for driving the PDP 100′ shown in FIG. 3 is similar to that according to the first exemplary embodiment of the present invention except that the scan pulse is concurrently applied to one of the odd-numbered scan electrodes and one of the even-numbered scan electrodes both corresponding to the one scan line.

FIG. 4 shows a diagram for representing the driving method of the plasma display device according to the exemplary embodiment of the present invention.

Hereinafter, cells defined by the first display regions and the address electrodes A1 to Am will be referred to as “Xodd line cells” (or odd cells), and cells defined by the second display regions and address electrodes A1 to Am will be referred to as “Xeven line cells” (or even cells). As described above, the first display regions are defined by the odd-numbered sustain electrodes Xodd and the scan electrodes Y1 to Yn, and the second display regions are defined by the even-numbered sustain electrodes Xeven and the scan electrodes Y1 to Yn. In addition, a cell, which is in the on-state, and has enough wall charges to generate a sustain discharge for the sustain period, will be referred to as “an on-cell”, and a cell, which is in the off-state, and does not have enough wall charges to generate the sustain discharge for the sustain period, will be referred to as “an off-cell”. A reset period for reset-discharging all of the cells whether or not they have undergone sustain-discharging in a previous subfield so as to initialize these cells, will be referred to as “a main reset period” (MR). A reset period for reset-discharging only those cells that have undergone sustain-discharging in the previous subfield so as to initialize only those cells, will be referred to as “a selective reset period” (SR). In addition, an address period for using a write addressing method will be referred to as “a write address period” (WA), and an address period for using an erase addressing method will be referred to as “an erase address period” (EA). The write addressing method is to address-discharge a cell which has been in the off-state to set or convert this cell to be in the on-state, and the erase addressing method is to address-discharge a cell which has been in the on-state to set or convert this cell to be in the off-state.

As shown in FIG. 4, frames are divided into odd-numbered frames and even-numbered frames. In one embodiment, the frames may be divided into two groups, one of the two groups may include one or more consecutive frames, and the other may include one or more other consecutive frame. Each frame is divided into a plurality of subfields SF1 to SF10. The subfields SF1 to SF10 each have a predetermined weight. While it has been illustrated that the subfields SF1 to SF10 respectively have weights of 1, 2, 4, 8, 8, 8, 8, 8, 8, and 8 in FIG. 4, the subfields SF1 to SF10 may have different weights in other embodiments.

In the first to third subfields SF1 to SF3 of the odd-numbered frame, subfield operations are performed for the Xodd line cells, but not performed for the Xeven line cells. In the first to third subfields SF1 to SF3 of the even-numbered frame, the subfields operations are performed for the Xeven line cells, but not performed for the Xodd line cell. Accordingly, no substantial light may be emitted from the Xodd line cells during the first to third subfields SF1 to SF3 of the odd-numbered frame. Similarly, no substantial light may be emitted from Xeven line cells during the first to third subfields SF1 to SF3 of the even-numbered frame. That is, light emission during the first to third subfields SF1 to SF3, which correspond to low grayscale subfields, is realized with respect to all cells during the two frames (i.e., odd- and even-numbered frames).

The following few paragraphs describe a method for driving the device during the odd-numbered frame. The first subfield SF1 of the odd-numbered frame includes a main reset period MR, a write address period WA, and a sustain period S. Subsequently, the second and third subfields SF2 and SF3 each include a selective reset period SR, a write address period WA, and a sustain period S. As described above, in the first to third subfields SF1 to SF3, operations of the reset, address, and sustain periods are performed for only the Xodd line cells. In addition, since the reset periods SR of the second and third subfields SF2 and SF3 are set to the selective reset period, the reset period may be shortened and contrast ratio may be increased. In one embodiment, a main reset period may be used for the reset period of the second or third subfield SF2 or SF3 instead of the selective reset period.

Subsequently, in the fourth subfield SF4 of the odd-numbered frame, operations of the main reset period MR, a second write address period WA2, and a second sustain period S2 are performed for the Xeven line cells after operations of the selective reset period SR, a first write address period WA1, and a first sustain period S1 are performed for the Xodd line cells. Since any discharge has been occurred for the Xeven line cells in the previous subfields SF1 to SF3, the operation of the main reset period MR is performed in the fourth subfield SF4 to initialize the Xeven line cells. In addition, when a sustain discharge is generated for the Xeven line cells during the second sustain period S2, the sustain discharge is generated again for the Xodd line cells.

Subfield operations are performed for both the Xodd and Xeven line cells in the fifth to tenth subfields SF5 to SF10. The fifth to tenth subfields SF5 to SF10 each include a first erase address period EA1, a second erase address period EA2, a first sustain period S1, and a second sustain period S2. In the fifth to tenth subfields SF5 to SF10, an operation of the first erase address period EA1 and an operation of the first sustain periods S1 are performed, for the Xodd line cells. Subsequently, an operation of the second erase address period EA2 and an operation of the second sustain periods S2 are performed, for the Xeven line cells. Since the cells sustain-discharged for the second sustain period S2 of the fourth subfield SF4 are in the on-state, cells to be set to the off-state are selected among these sustain-discharged cells for the erase periods EA1 and EA2 of the fifth subfield SF5. In addition, for the respective erase address periods EA1 and EA2 of the sixth to tenth subfields SF6 to SF10, cells to be set to the off-state are selected among the cells sustain-discharged for the second sustain period S2 of the previous subfield (i.e., the on-cells). When the sustain period S1 or S2 is illustrated in both the Xodd line cells and the Xeven line cells in FIG. 4, the sustain discharge is generated in the Xodd line cells and the Xeven line cells. That is, a sustain pulse is applied to the odd-numbered sustain electrode Xodd and the even-numbered sustain electrode Xeven.

In addition, a driving method of the even-numbered frame is substantially the same as that of the odd-numbered frame except that an order of the operations of the Xodd line cells and the Xeven line cells is reversed, and therefore detailed descriptions thereof will be omitted. That is, the operations of the reset, write address, and sustain periods are performed for the Xeven line cells in the first to third subfields SF1 to SF3. In the fourth subfield SF4, the operations of the reset, write address, and sustain periods are performed for the Xodd line cells after the operations of the reset, write address, and sustain periods are performed for the Xeven line cells. In addition, in the fifth to tenth subfields SF5 to SF10 of the even-numbered frame, the operations of the erase address period and the sustain period are performed for the Xeven line cells, and subsequently, the operations of the erase address period and the sustain period are performed for the Xodd line cells.

In FIG. 4, the weights of the fifth to eighth subfields SF5 to SF10 are the same as that of the fourth subfield SF4 because the off-cells cannot be set to be in the on-state again in a subsequent subfield when the erase addressing method is applied for the erase address period. In one embodiment, the respective weights of the fifth to eighth subfields SF5 to SF10 may be set to a weight different from 8, for example, a value higher than 8, but all of the 256 gray levels may not be expressed. Accordingly, a half-toning method such as a dithering method may be used to express the respective 256 grayscales when the weights of the fifth to eighth subfields SF5 to SF10 are set to a weight value different from 8.

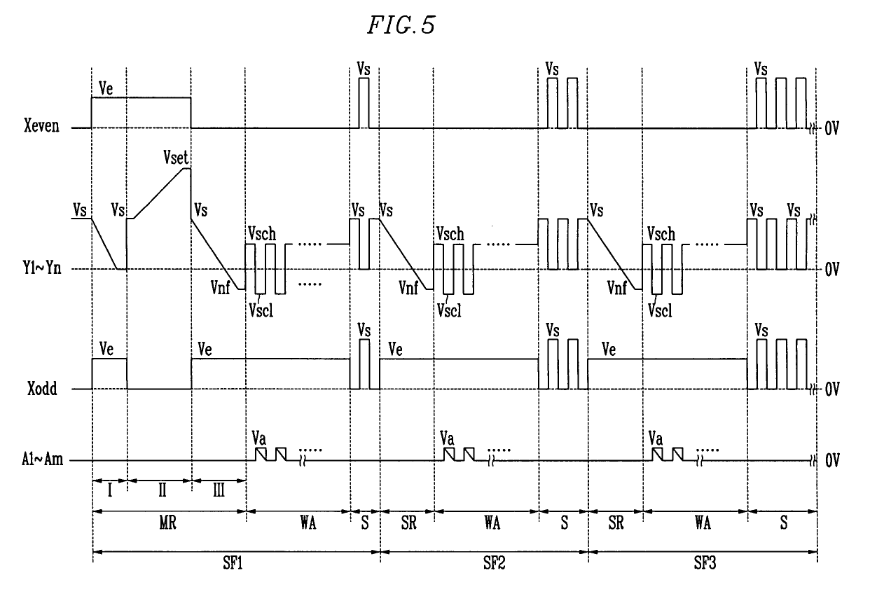

Driving waveforms for using the driving method of FIG. 4 will now be described with reference to FIG. 5 to FIG. 9. The driving waveforms of the odd-numbered frames are shown in FIG. 5 to FIG. 9. The driving waveforms of the even-numbered frames may be realized by applying the driving waveforms which are applied to the odd-numbered sustain electrode Xodd during the odd-numbered frames to the even-numbered sustain electrode Xeven and by applying the driving waveforms which are applied to the even-numbered sustain electrode Xeven during the odd-numbered frames to the odd-numbered sustain electrode Xodd. Therefore, the driving waveforms applied to the odd-numbered frame will be described below.

FIG. 5 shows a diagram representing driving waveforms of the first to third subfields SF1 to SF3, among the driving waveforms of the plasma display device according to the exemplary embodiment of the present invention.

As shown in FIG. 5, the first subfield includes the main reset period MR, the write address period WA, and the sustain period S, and the second and third subfields respectively include the selective reset periods SR, the write address periods WA, and the sustain periods S.

The main reset period MR of the first subfield SF1 includes an erase period I, a rising period II, and a falling period III.

For the erase period I of the main reset period MR, a voltage at the scan electrodes Y1 to Yn is gradually decreased from a voltage Vs to a reference voltage (0V in FIG. 5), while a voltage Ve is applied to the odd-numbered sustain electrode Xodd and the even-numbered sustain electrode Xeven. The voltage Ve is higher than the reference voltage 0V in the described embodiment. Before the erase period, i.e., in the last subfield of the previous frame, positive wall charges and negative wall charges were respectively formed on the sustain and scan electrodes of the sustain-discharged cells. These wall charges are substantially eliminated during the erase period I in the described embodiment. Accordingly, state of the cells sustain-discharged in the last subfield of the previous frame becomes similar to that of the cell that has not been sustain-discharged in the last subfield. In one embodiment, voltages at the sustain electrodes Xeven and Xodd may be gradually increased while the scan electrodes Y1 to Yn are biased at the reference voltage 0V during the erase period I. In one embodiment, at least one pulse for eliminating the wall charges, for example, at least one square pulse having a narrow width, may be applied to the scan electrodes Y1 to Yn and/or the sustain electrodes Xodd and Xeven.

Subsequently, in the rising period II of the main reset period MR, the voltage at the scan electrodes Y1 to Yn is gradually increased from the Vs voltage to a Vset voltage while the Ve voltage is applied to the even-numbered sustain electrode Xeven and the reference voltage 0V is applied to the odd-numbered sustain electrode Xodd. In addition, the reference voltage 0V is applied to the address electrodes A1 to Am. Since the reference voltage 0V is applied to the odd-numbered sustain electrode Xodd, a weak reset discharge occurs between the odd-numbered sustain electrode Xodd and the odd portions of the scan electrodes Y1 to Yn. As describe above, the odd portions of the scan electrodes Y1 to Yn may correspond to the odd-numbered scan electrodes (Y1′, . . . , Yi′, . . . , Y(n−1)′ of FIG. 3) in the PDP 100′ shown in FIG. 3. Since the Ve voltage is applied to the even-numbered sustain electrodes Xeven, the reset discharge is not generated between the even-numbered sustain electrodes Xeven and the even portions of the scan electrodes Y1 to Yn. As describe above, the even portions of the scan electrodes Y1 to Yn may correspond to the even-numbered scan electrodes (Y2′, . . . , Y(i+1)′, . . . , Yn′) in the PDP 100′ shown in FIG. 3. In addition, the weak reset discharge occurs between the scan electrodes Y1 to Yn and the address electrodes A1 to Am. Accordingly, the negative wall charges are formed in the odd portions of the scan electrodes Y1 to Yn. In addition, the positive wall charges are formed on the odd-numbered sustain electrodes Xodd, and the negative wall charges are formed on the address electrodes A1 to Am. That is, the reset discharge is generated only in the Xodd line cells so as to initialize the Xodd line cells.

In addition, the wall charges are formed such that a sum of an external voltage and a wall voltage may be maintained at a discharge firing voltage, since the weak discharge is generated in the cell when the voltage at the electrode is gradually changed as shown in FIG. 5.

In addition, the Vset voltage may be high enough to generate a discharge in the cells in every condition since all the Xodd line cells are initialized during the main reset period MR of the first subfield SF1. The Vs voltage may be lower than a discharge firing voltage between the scan electrodes Y1 to Yn and the sustain electrodes X1 to Xn. The Vs voltage may be set to be equal to a voltage of a sustain pulse applied for the sustain period S in FIG. 5 to reduce the number of power sources for supplying the voltages during the reset and sustain periods, and another voltage may be substituted for the Vs voltage. The Ve voltage may be set such that the reset discharge may not be generated between the scan electrodes Y1 to Yn and the even-numbered sustain electrode Xeven by a difference between the Vset voltage and the Ve voltage.

During the falling period III of the main reset period MR, the voltage at the scan electrodes Y1 to Yn is gradually decreased from the Vs voltage to a Vnf voltage. In this case, the reference voltage 0V is applied to the even-numbered scan electrodes Xeven, the Ve voltage is applied to the odd-numbered scan electrodes Xodd, and the reference voltage 0V is applied to the address electrodes A1 to Am. Then, the weak reset discharge occurs between the odd portions of the scan electrodes Y1 to Yn and the odd-numbered sustain electrodes Xodd and between the scan electrodes Y1 to Yn and the address electrodes A1 to Am. Accordingly, the negative wall charges formed on the odd portions of the scan electrodes Y1 to Yn and the positive wall charges formed on the odd-numbered sustain electrodes Xodd and the address electrodes A1 to Am are substantially eliminated. However, since the weak discharge has not been generated between the second portions of the scan electrode Y1 to Yn and the even-numbered sustain electrodes Xeven during the rising period II, the reset discharge is not generated between the even portions of the scan electrode Y1 to Yn and the even-numbered sustain electrodes Xeven receiving the reference voltage 0V during the falling period III. Therefore, the Xodd line cells are reset-discharged to be initialized as the off-cells and have the wall charges for an address operation. The Ve voltage and the Vnf voltage may be set such that the wall voltage between the odd portions of the scan electrodes Y1 to Yn and the odd-numbered sustain electrodes Xodd may reach 0V. Then, the off-cells that are not address-discharged during the writing address period may be prevented from being discharged during the sustain period. In addition, since the address electrodes A1 to Am are maintained at the reference voltage 0V, the wall voltage between the second portions of the scan electrodes and the address electrodes A1 to Am is determined by the Vnf voltage.

Since the reset discharge is only generated in the Xodd line cells for the main reset period of the first subfield SF1, the appropriate wall charges for the address operation are formed at the Xodd line cells. However, the appropriate wall charges for the address operation are not formed in the Xeven line cells since the reset discharge is not generated therein. In addition, the wall charge state of the Xodd line cells becomes the off-state by the reset discharge.

Subsequently, for the write address period WA of the first subfield SF1, to select a on-cell among the Xodd line cells, a scan pulse having a Vscl voltage is sequentially applied to the scan electrodes Y1 to Yn (i.e., the scan lines) and a Vsch voltage is applied to the scan electrodes not receiving the Vscl voltage. In the PDP 100′ shown in FIG. 3, the scan pulse may be sequentially applied to the scan lines, i.e., pairs (Y1′ and Y2′; Y3′ and Y4′; . . . ) of the scan electrodes In addition, the reference voltage 0V and the Ve voltage are respectively applied to the even-numbered sustain electrodes Xeven and the odd-numbered sustain electrodes Xodd. The Vscl voltage is referred to as a scan voltage, and the Vsch voltage is referred to as a non-scan voltage. An address pulse having a Va voltage is applied to address electrodes passing through cells to be selected among the Xodd line cells defined by the scan electrode receiving the Vscl voltage, and the other address electrodes are biased at the reference voltage 0V.

Then, an address-discharge is generated at a cell formed by the address electrode receiving the Va voltage, the scan electrode receiving the Vscl voltage, and the even-numbered sustain electrode Xeven receiving the Ve voltage. As a result, the positive wall charges are formed on the odd portions of the scan electrodes of the address-discharged cells, and the negative wall charges are formed on the address and sustain electrodes of the address-discharged cells. That is, the address-discharged cells among the Xodd line cells are set from the off-state to the on-state to be on-cells. However, since the Xeven line cells are not initialized for the main reset period MR of the first subfield SF1 and the even-numbered sustain electrode Xodds are biased at the reference voltage for the write address period WA, the address discharge is not generated in the Xeven line cells.

For the sustain period S of the first subfield SF1, the sustain pulse having the voltage Vs is alternately applied to the scan electrodes Y1 to Yn and the sustain electrodes Xodd and Xeven. A sustain discharge is generated by the sustain pulse in the cells (i.e., the on-cells) set to the on-state for the write address period WA of the first subfield SF1.

The number of the sustain pulses may be appropriately determined according to the weight of the first subfield SF1.

Driving waveforms of the second subfield SF2 and the third subfield SF3 are similar to that of the first subfield SF1 except for the driving waveforms applied for the reset period SR and the number of sustain pulses applied for the sustain period S.

In more detail, as shown in FIG. 5, for the reset periods SR of the second and third subfields SF2 and SF3 which are the selective reset periods, the voltage at the scan electrodes Y1 to Yn is gradually decreased from the Vs voltage to the Vnf voltage without being gradually increased. Therefore, the cells sustain-discharged (i.e., the on-cells) in the previous subfield are reset-discharged to be set to the off-cells.

After the sustain period S of the first subfield SF1, the negative wall charges and the positive wall charges are respectively formed on the odd portions of the scan electrodes and the sustain electrodes of the sustain-discharged cells (i.e., the cells sustain-discharged in the first subfield SF1 among the Xodd line cells) since the last sustain pulse is applied to the scan electrodes Y1 to Yn. While the reference voltage 0V and the Ve voltage are respectively applied to the even-numbered sustain electrodes Xeven and the odd-numbered sustain electrodes Xodd, a voltage at the scan electrodes Y1 to Yn is gradually decreased from the Vs voltage to the Vnf voltage during the selective reset period SR. Then, the reset discharge is generated in the cells sustain-discharged for the sustain period of the first subfield SF1. However, since the cells that are not sustain-discharged in the first subfield SF1 among the Xodd line cells are maintained at wall charge state (i.e., off-state) of the main reset period MR of the first subfield SF1, they are not reset-discharged. That is, it is not required to reset-discharge the off-cells of the first subfield among the Xodd line cells. Accordingly, the selective reset period is applied to the reset period SR of the second subfield SF2, and all the Xodd line cells are initialized to the off-state during the selective reset period SR.

An operation of the selective reset period SR of the third subfield SF3 is the same as that of the selective reset period SR of the second subfield SF2, and therefore detailed descriptions thereof will be omitted. The number of the sustain pulses, which are applied during each of sustain periods S of the second and third subfields SF2 and SF3, is appropriately determined according to the weight of the corresponding subfields SF2 and SF3.

As described above, the reset, write address, and sustain discharge operations are performed for only the Xodd line cells in the first to third subfields SF1 to SF3 of the odd-numbered frame. In the first to third subfields SF1 to SF3 of the even-numbered frame, the reset, write address, and sustain discharge operations are performed for only the Xeven line cells in a like manner described above.

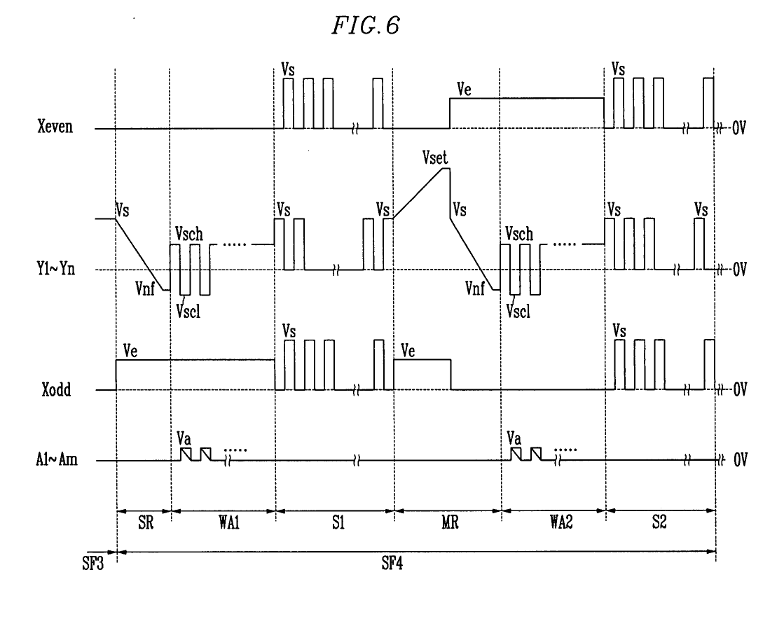

FIG. 6 shows a diagram representing driving waveforms of the fourth subfield SF4 according to the first exemplary embodiment of the present invention.

First, the operations of the selective reset period SR, the first write address period WA1, and the first sustain period S1 are performed for the Xodd line cells. As shown in FIG. 6, driving waveforms of the selective reset period SR, the first write address period WA1, and the first sustain period S1 in the fourth subfield SF4 are similar to those in the second subfield SF2 or the third subfield SF3, except for the number of the sustain pulses applied for the first sustain period S1 which are determined by the weight of the corresponding subfield.

In more detail, for the selective reset period SR, the reset operation for initializing the Xodd line cells to the off-state is performed. That is, the voltage at the scan electrodes Y1 to Yn is gradually decreased from the Vs voltage to the Vnf voltage while the Ve voltage is applied to the odd-numbered sustain electrodes Xodd and the reference voltage 0V is applied to the even-numbered sustain electrodes Xeven. Subsequently, the write address operation for selecting cells to be set as on-cells among the Xodd line cells is performed for the first write address period WA1. The sustain discharge operation is performed to sustain-discharge the selected on-cells for the first sustain period S1 by alternately applying the sustain pulse to the scan electrodes Y1 to Yn and the sustain electrodes Xeven and Xodd.

Subsequently, the operations of the main reset period MR, the second write address period WA2, and the second sustain period S2 are performed for the Xeven line cells.

As shown in FIG. 6, for the main reset period MR, the voltage at the scan electrodes Y1 to Yn is gradually increased from the Vs voltage to the Vset voltage while the reference voltage 0V and the Ve voltage are respectively applied to the even-numbered sustain electrodes Xeven and the odd-numbered sustain electrodes Xodd. Subsequently, the voltage at the scan electrodes Y1 to Yn is gradually decreased from the Vs voltage to the Vnf voltage while the Ve voltage and the reference voltage 0V are respectively applied to the even-numbered sustain electrodes Xeven and the odd-numbered sustain electrodes Xodd. That is, the driving waveforms applied to the even-numbered sustain electrode Xeven and the odd-numbered sustain electrode Xodd for the main reset period MR of the first subfield SF1 shown in FIG. 5 are respectively applied to the odd-numbered sustain electrodes Xodd and the even-numbered sustain electrodes Xeven in FIG. 6. Therefore, the reset discharge is generated in the Xeven line cells such that the Xeven line cells are initialized to the off-state.

Subsequently, for the second write address period WA2, since the Ve voltage and the reference voltage 0V are respectively applied to the even-numbered sustain electrodes Xeven and the odd-numbered sustain electrodes Xodd, the write address operation is performed in the Xeven line cells. That is, on-cells are selected among the Xeven line cells by the address-discharge. As a result, the positive wall charges and the negative wall charges are respectively formed on the second portions of the scan electrodes and the sustain electrodes of the on-cells among the Xeven line cells.

For the second sustain period S2, the sustain discharge is generated in the on-cells selected for the second write address period WA2 by alternately applying the sustain pulse to the scan electrodes Y1 to Yn and the sustain electrodes Xeven and Xodd. At this time, the cells (i.e., the on-cells of the Xodd line cells) sustain-discharged for the first sustain period S1 are maintained at the on-state since the discharge is not generated for the main reset period MR and the second write address period WA2. Accordingly, the sustain-discharge is also generated in the cells sustain-discharged for the first sustain period S1 (i.e., the on-cells of the Xodd line cells) when the sustain pulse is applied for the second sustain period S2. That is, the on-cells selected for the first write address period WA1 and the on-cells selected for the second write address period WA2 are sustain-discharged for the second sustain period S2. Therefore, since the Xodd line cells are sustain-discharged for the first sustain period and the second sustain period, more sustain discharges are generated in the Xodd line cells compared to the Xeven line cells.

On the other hand, since the last sustain pulse is applied to the scan electrodes Y1 to Yn for the first sustain period S1 of the fourth subfield SF4, the negative wall charges and the positive wall charges are respectively formed on the odd portions of the scan electrodes and the sustain electrodes of the on-cells after the first sustain period S1. Therefore, the wall voltage is formed such that a wall potential of the sustain electrodes is higher than that of the odd portions of the scan electrodes. The wall charge state of the on-cells is still maintained after the main reset period MR since the reset discharge is not generated in the Xodd line cells for the main reset period MR. However, the voltage at the odd-numbered sustain electrodes Xodd is higher than the voltage at the scan electrodes Y1 to Yn since the reference voltage 0V is applied to the odd-numbered sustain electrode Xodd when the scan voltage Vscl is sequentially applied to the scan electrodes Y1 to Yn for the second write address period WA2. Accordingly, the discharge may be generated in the on-cells by the wall voltages and the difference |Vscl| of the voltages applied for the second write address period WA2 such that the wall charge state of the on-cells may be varied. As a result, these on-cells may not be sustain-discharged during the second sustain period S2.

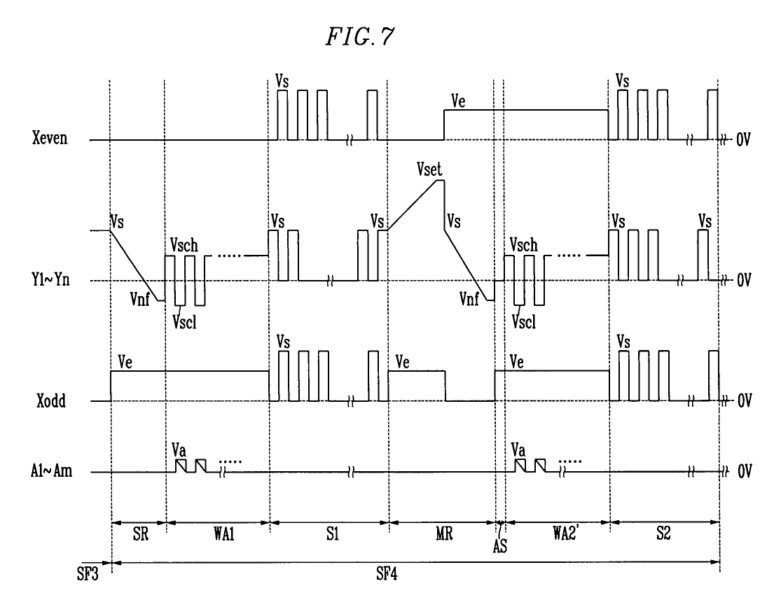

A method for preventing wall charge variation of the cells sustain-discharged for the first sustain period S1 will now be described with reference to FIG. 7.

FIG. 7 shows a diagram representing driving waveforms of the fourth subfield SF4 according to the second exemplary embodiment of the present invention. As shown in FIG. 7, the driving waveforms of the fourth subfield according to the second exemplary embodiment further includes a correction period AS between the main reset period MR and a second write address period WA2′. In addition, the driving waveforms are the same as those according to the first exemplary embodiment except that the Ve voltage is applied to the odd-numbered sustain electrodes Xodd for the second write address period WA2′.

In more detail, first, for the correction period AS after the main reset period MR, the Ve voltage is applied to both the even-numbered sustain electrodes Xeven and the odd-numbered sustain electrodes Xodd, and the reference voltage 0V is applied to the scan electrodes Y1 to Yn. Since the Xeven line cells are initialized for the main reset period MR, no discharge is generated for the correction period AS. However, as described above, the cells sustain-discharged for the first sustain period S1 (i.e., the on-cells) among the Xodd line cells are maintained at the wall charge state after the first sustain period S1 during the main reset period MR. That is, the negative wall charges and the positive wall charges are respectively formed on the odd portions of the scan electrodes and the sustain electrodes of the on-cells among the Xodd line cells after the first sustain period 41. In this case, the on-cells are sustain-discharged again for the correction period AS by a sum of the wall voltage and the Ve voltage since the Ve voltage is applied to the odd-numbered sustain electrodes Xodd and the reference voltage 0V is applied to the scan electrodes Y1 to Yn. While the Ve voltage is illustrated to be lower than the Vs voltage in FIG. 7, the Ve voltage may be set to a voltage similar to the Vs voltage in one embodiment. Then, the on-cells sustain-discharged for the first sustain period S1 is sustain-discharged for the correction period AS once more. When the Ve voltage is set to the voltage similar to the Vs voltage, the Vnf voltage may be set to a further lower voltage.

As described above, since the on-cells sustain-discharged for the first sustain period S1 are sustain-discharged again for the correction period AS, the negative wall charges and the positive wall charges are respectively formed on the sustain electrodes and the odd portions of the scan electrodes of the on-cells. For the second write address period WA2′, the scan pulse is sequentially applied to the scan electrodes Y1 to Yn while the Ve voltage is applied to all the sustain electrodes Xeven and Xodd. Accordingly, the wall charge state of the on-cells sustain-discharged for the first sustain period S1 is not varied since the discharge is not generated by the wall voltage formed for the correction period AS when the scan pulse is applied for the second write address period WA2′. In addition, on-cells are selected among the Xeven line cells for the second write address period WA2′ in a like manner of the second write address period WA2 shown in FIG. 6.

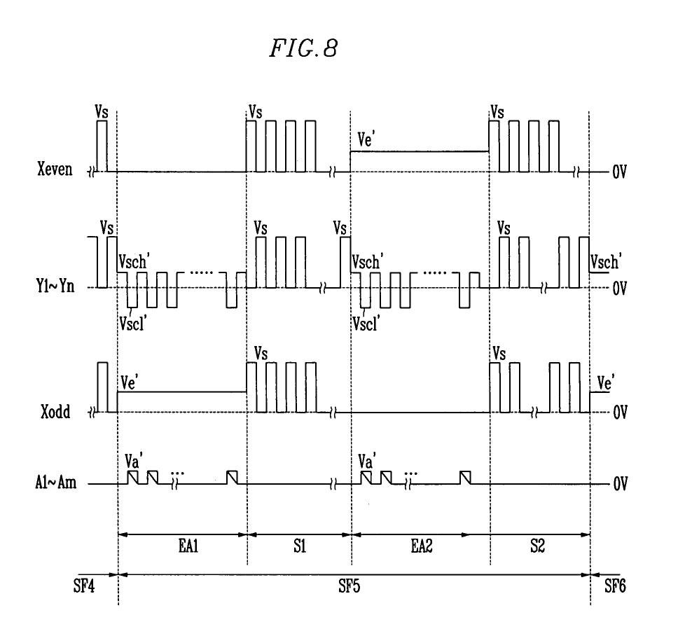

FIG. 8 shows a diagram representing driving waveforms of the fifth subfield SF5 according to the exemplary embodiment of the present invention.

As shown in FIG. 8, the fifth subfield SF5 includes the first erase address period EA1 for the Xodd line cells and the first sustain period S1, and the second erase address period EA2 for the Xeven line cells and second sustain period S2. In order to use the erase addressing method, a cell is required to be in the on-state. Since the cells sustain-discharged for the fourth subfield SF4 are in the on-state, the first erase address period EA1 may be provided consecutively to the sustain period S2 of the fourth subfield SF4.

For the first erase address period EA1 of the fifth subfield SF5, a ground voltage 0V and a Ve′ voltage are respectively applied to the even-numbered sustain electrodes Xeven and the odd-numbered sustain electrodes Xodd. A scan pulse having a Vscl′ voltage is sequentially applied to the scan electrodes Y1 to Yn (i.e., the scan lines) and a Vsch′ voltage is applied to the scan electrodes not receiving the Vscl′ voltage. In the PDP 100′ of FIG. 3, the scan pulse having the Vscl′ voltage may be sequentially applied to the scan lines, i.e., pairs of the scan electrodes. The Ve′ voltage is lower than the Ve voltage applied for the write address period of the first to fourth subfields. Since the last sustain pulse is applied to the scan electrodes Y1 to Yn for the second sustain period S2 of the fourth subfield SF4, the negative wall charges and the positive wall charges are respectively formed on the scan and sustain electrodes of the on-cells sustain-discharged for the sustain period S2 of the fourth subfield SF4. A weak discharge is generated between the scan electrode receiving the scan voltage Vscl′ and the address electrode receiving the address voltage Va′ since a difference (Va′+|Vscl′|) between the scan voltage Vscl′ and the address voltage Va′ is added to the wall voltage formed by the wall charges of the sustain discharged cells. At this time, since the Ve′ voltage is applied to the odd-numbered sustain electrodes Xodd, the weak discharge is spread to the odd-numbered sustain electrodes Xodd such that an address discharge is generated between the scan electrode receiving Vscl′ and the odd-numbered sustain electrode Xodd receiving the Ve′ voltage. As a result, the wall charges are substantially eliminated in the on-cells defined by the address electrodes receiving Va voltage, the odd portions of the scan electrodes receiving the Vscl′ voltage, and the odd-numbered sustain electrodes receiving Ve′ such that these on-cells is switched to the off-state (i.e., off-cells). However, since the even-numbered sustain electrode Xeven is biased at the reference voltage 0V, the weak discharge generated between the scan electrode and the address electrode and the discharge is not spread to the even-numbered sustain electrode Xeven. Accordingly, an erase address operation is not performed at the Xeven line cells when the scan voltage Vscl′ and the address voltage Va′ are applied to the Xeven line cells. As described above, the erase address operation may be determined depending on whether the Ve′ voltage is applied.

The negative wall charges and the positive wall charges are sufficiently formed on the scan and sustain electrodes of the cells sustain-discharged for the sustain period S2 of the fourth subfield SF4 since the last sustain pulse is applied to the scan electrodes Y1 to Yn, and therefore the erase address operation may be performed by the Ve′ voltage that is lower than the Ve voltage. Accordingly, the Ve′ voltage applied for the first erase address period EA1 is lower than the Ve voltage, as described above. In addition, the scan voltage Vscl′ and the non-scan voltage Vsch′ for the first erase address period EA1 may be set respectively higher than the scan voltage Vscl and the non-scan voltage Vsch for the write address period of the first to fourth subfields SF1 to SF4 in FIG. 8, since the erase operation for the first erase address period EA1 is to set the sustain-discharged cells to the off-state. In addition, a width of the scan pulse applied for the first erase address period EA1 may be shorter than that applied for the write address period of the first to fourth subfields SF1 to SF4. Since the erase address operation does not substantially form the wall charges in the address-discharged cells, the scan pulse width for the erase address period may be reduced.

For the first sustain period S1 of the fifth subfield SF5, the cells remaining at the on-state (i.e., the on-cells of Xeven line cells, and the cells which are not address-discharged among the on-cells of the Xodd line cells) are sustain-discharged by alternately applying the sustain pulse to the scan electrodes Y1 to Yn and the sustain electrodes Xodd and Xeven. In this case, the number of the sustain pulses is appropriately selected according to the weight of the fifth subfield SF5.

The sustain pulse applied for the first sustain period S1 can supplement the lost wall charges of the Xeven line cells for the first erase address period EA1. As described above, when the scan voltage Vscl′ and the address voltage Va′ are respectively applied to the scan and address electrodes for the first erase address period EA1, the weak discharge is generated between the even portions of the scan electrodes and the address electrodes of the Xeven line cells although the reference voltage 0V is applied to the even-numbered sustain electrodes Xeven. Accordingly, the erase address operation may not be appropriately performed at the on-cells of the Xeven line cells for the second erase address period EA2 since the wall charges formed on the address electrode of the on-cells of the Xeven line cells are substantially eliminated by the weak discharge. However, the eliminated wall charges are supplemented by the operation of the first sustain period S1. Since the on-cells of the Xeven line cells are not selected for the first erase address period EA1, the sustain discharge is generated at the on-cells of the Xeven line cells when the sustain pulse is applied for the first sustain period S1 although some wall charges are eliminated for the first erase address period EA1. The eliminated wall charges are supplemented by the sustain discharge.

Subsequently, the Ve′ voltage and the reference voltage 0V are respectively applied to the even-numbered sustain electrode Xeven and the odd-numbered sustain electrode Xodd for the second erase address period EA2. In addition, the scan pulse having the Vscl′ voltage is sequentially applied to the scan electrodes Y1 to Yn (i.e., the scan lines) and the Vsch′ voltage is applied to the scan electrodes not receiving the Vscl′ voltage. The scan pulse may be sequentially applied to the scan lines, i.e., pairs of the scan electrodes in the PDP 100′ shown in FIG. 3. Since the Ve′ voltage is applied to the even-numbered sustain electrodes Xeven, the cells to be set as the off-cells are selected from the Xeven line cells for the second erase address period EA2.

In addition, the sustain pulse is alternately applied to the scan electrodes Y1 to Yn and the sustain electrodes Xodd and Xeven for the second sustain period S2.

Then, the cells remaining at the on-state (i.e., the cells which are sustain discharged during the first sustain period S1, and the cells which are not address-discharged among the on-cells of the Xeven line cells during the second erase address period EA2) are sustain-discharged. Here, the number of the sustain pulses applied for the second sustain period S2 is set to be equal to the number of the sustain pulses applied for the first sustain period S1. In addition, some wall charges of the cell remaining at the on-state among the Xodd line cells are eliminated for the second erase address period EA2, but the eliminated wall charges are supplemented by the sustain discharge for the second sustain period S2 in a like manner of the first sustain period S1. Accordingly, the erase address operation can be appropriately performed at the Xodd line cells for the first erase address period EA1 of the sixth subfield SF6 following the fifth subfield SF5.

The driving waveforms applied to the sixth subfield to tenth subfields SF6 to SF10 are the same as those of the fifth subfield SF5 shown in FIG. 8, and therefore detailed descriptions thereof will be omitted.

On the other hand, more sustain discharges are generated in the on-cells of the Xodd line cells compared to the on-cells of the Xeven line cells during the fourth subfield as described above. However, the difference between the number of the sustain discharges of the Xodd line cells and that of the Xeven line cells may be supplemented in the following subfield or the following frame.

First, it is assumed that any one cell of the Xodd line cells and any one cell of the Xeven line cells are set to the on-state in the fourth subfield SF4, and are set to the off-state in j^{th} subfield SFj of the fifth to tenth subfields SF5 to SF10. Then the on-cell of the Xodd line cells is sustain-discharged from the first sustain period S1 of the fourth subfield SF4 to the second sustain period S2 of the (j−1)^{th} subfield SF(j−1). The on-cell of the Xeven line cells is sustain-discharged from the second sustain period S2 of the fourth subfield SF4 to the first sustain period S1 of the j^{th} subfield SFj. Therefore, the number of the sustain discharges in the on-cell of the Xodd line cells is the same as the number of sustain discharges in the on-cell of the Xeven line cells.

Next, it is assumed that any one cell of the Xodd line cells and any one cell of the Xeven line cells are set to the on-state in the fourth subfield SF4, and are not set to the off-state during the fifth to tenth subfields SF5 to SF10. Then the on-cell of the Xodd line cells is sustain-discharged from the first sustain period S1 of the fourth subfield SF4 to the second sustain period S2 of the tenth subfield SF10. The on-cell of the Xeven line cells is sustain-discharged from the second sustain period S2 of the fourth subfield SF4 to the second sustain period S2 of the tenth subfield SF10. Therefore, the number of the sustain discharges in the on-cell of the Xodd line cells is more than the number of sustain discharges in the on-cell of the Xeven line cells However, the number of the sustain discharges may become the same at both of the Xodd line cells and Xeven line cells throughout the two frames since the address operation is performed at the Xeven line cells before the address operation is performed at the Xodd line cells in the even-numbered frame in a reverse order of the odd-numbered frame.

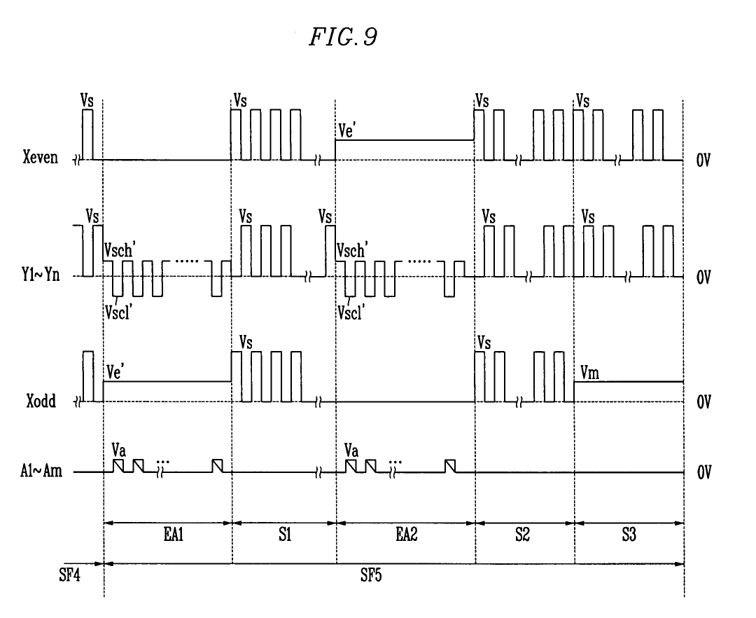

On the other hand, to equally set the number of the sustain discharges in one frame, driving waveforms shown in FIG. 9 may be applied in one of the fifth to tenth subfields SF5 to SF10. FIG. 9 shows a diagram representing the driving waveforms for compensating the number of the sustain discharges between the Xodd line cells and the Xeven line cells. While a compensation sustain period S3 for compensating the number of the sustain discharges is additionally provided for the driving waveforms in the fifth subfield SF5 in FIG. 9, the driving waveforms shown in FIG. 9 may be applied in any one of the fifth to tenth subfields. For the compensation sustain period S3, a predetermined voltage Vm is applied to the odd-numbered sustain electrodes Xodd so that the sustain discharge is not generated at the Xodd line cells. In addition, for the compensation sustain period S3, the sustain pulse is alternately applied to the even-numbered sustain electrodes Xeven and the scan electrodes Y1 to Yn so that the sustain discharge is generated at the Xeven line cells. Furthermore, the number of the sustain pluses of the compensation sustain period S3 is set to be substantially the same as the number of the sustain pulses of the first sustain period S1. Therefore, the difference of the number of the sustain discharges may be compensated since the sustain discharge is generated only at the Xeven line cells for the compensation sustain period S3. The Vm voltage is set to be lower than the level of the Vs voltage so that the sustain discharge may not generated. In one embodiment, the odd-numbered sustain electrode Xodd may be floated for the compensation sustain period S3.

The above-described driving waveforms of the plasma display device are to be applied in the odd-numbered frame. In the even-numbered frame, the driving waveforms applied to the odd-numbered sustain electrodes Xodd in FIG. 5 to FIG. 9 are applied to the even-numbered sustain electrodes Xeven.

As described above, according to the exemplary embodiments of the present invention, the number of scan lines is about half of the number of display regions. Therefore, the number of scan circuits respectively coupled to the scan lines can be reduced.. Furthermore, as illustrated in FIG. 2, the number of scan and sustain electrodes of the PDP according to the first exemplary embodiment of the present invention may be reduced by half compared to the electrode number of the PDP according to the prior art (i.e., the PDP in which the sustain and the scan electrodes define one display region) when it is realized with the same resolution

In addition, a contrast ratio may be improved according to the exemplary embodiments of the present invention. Since the reset discharge in the reset period is generated only at the Xodd line cells in the respective first to third subfields SF1 to SF3, the contrast ratio may be enhanced compared to a case in which the reset discharge is generated at both of the Xodd line cells and the Xeven line cells. In addition, the contrast ratio may be further enhanced since the reset discharge is not required in the respective fifth to tenth subfields SF5 to SF10 due to the erase address operation performed at the cells sustain-discharged in the fourth subfield SF4. In addition, the address operation may be performed at high speed since the erase address operation is performed in the fifth to tenth subfields SF5 to SF10.

According to the exemplary embodiments of the present invention, the number of electrodes is reduced since the sustain electrode or the scan electrode defines two display region, and therefore the number of scan circuits may be reduced. In addition, the number of scan circuits may be reduced since the scan pulse is concurrently applied to the two neighboring scan electrodes.

While the invention has been described in connection with certain exemplary embodiments, it is to be understood that the invention is not limited to the disclosed embodiments, but, on the contrary, is intended to cover various modifications and arrangements included within the spirit and scope of the appended claims and their equivalents.

What is claimed is:

1. A plasma display device, comprising:
a plasma display panel comprising a plurality of first display regions extending in a first direction, a plurality of second display regions extending in the first direction, a plurality of first electrodes extending in a second direction crossing the first direction, a plurality of first cells defined by the plurality of first display regions and the plurality of first electrodes, and a plurality of second cells defined by the plurality of second display regions and the plurality of first electrodes;
a controller adapted to drive the plasma display device during frames comprising a first frame and a second frame, and to divide each frame into a plurality of subfields comprising a first subfield and a second subfield; and
a driver adapted to,
in the first subfield of the first frame:
select at least one on-cell among the plurality of first cells and/or the plurality of second cells, by using a first address method for address-discharging at least one of the cells at off-state to place the at least one of the cells at on-state; and
sustain-discharge the at least one on-cell; and
in the second subfield of the first frame:
select at least one off-cell among the plurality of first cells, by using a second address method for address-discharging at least one of the cells at on-state to place the at least one of the cells at off-state, during a first address period;
sustain-discharge at least one of the cells remaining at on-state after the first address period, during a first sustain period following the first address period;
select at least one off-cell among the plurality of second cells by using the second address method during a second address period following the first sustain period; and
sustain-discharge at least one of the cells remaining at on-state after the second address period, during a second sustain period following the second address period.

2. The plasma display device of claim 1, wherein the driver is further adapted to,
in the second subfield of the second frame:
select at least one off-cell among the plurality of second cells by using the second address method during a first address period;
sustain-discharge at least one of the cells remaining at on-state after the first address period, during a first sustain period following the first address period;
select at least one off-cell among the plurality of first cells by using the second address method during a second address period following the first sustain period; and
sustain-discharge at least one of the cells remaining at on-state after the second address period, during a second sustain period following the second address period.

3. The plasma display device of claim 2, wherein the driver is further adapted to,
in order to select the at least one on-cell in the first subfield of the first frame:
select at least one first on-cell among the plurality of first cells during a first address period; and
select at least one second on-cell among the plurality of second cells during a second address period, and
in order to sustain-discharge the at least one on-cell in the first subfield of the first frame:
sustain-discharge the at least one first on-cell during a first sustain period between the first and second address periods; and
sustain-discharge the at least one first on-cell and the at least one second on-cell during a second sustain period following the second address period.

4. The plasma display device of claim 2, wherein the driver is further adapted to,
in the first subfield of the second frame:
select at least one first on-cell among the plurality of second cells by using the first address method during a first address period;
sustain-discharge the at least one first on-cell during a first sustain period following the first address period;
select at least one second on-cell among the plurality of first cells by using the first address method during a second address period following the first sustain period; and
sustain-discharge the at least one first on-cell and the at least one second on-cell during a second sustain period following the second address period,
wherein the first subfield is previous to the second subfield.

5. The plasma display device of claim 4, wherein a weight of the first subfield of the first frame is the same as a weight of the first subfield of the second frame, and a weight of the second subfield of the first frame is the same as a weight of the second subfield of the second frame.

6. The plasma display device of claim 1, wherein the plurality of subfields further comprise a third subfield previous to the first subfield,
wherein the driver is further adapted to,
in the third subfield of the first frame:
select at least one first on-cell among the plurality of first cells by using the first address method during an address period; and
sustain-discharge the at least one first on-cell during a sustain period following the address period; and
in the third subfield of the second frame:
select at least one second on-cell among the plurality of second cells by using the first address method during an address period; and
sustain-discharge the at least one second on-cell during a sustain period following the address period.

7. The plasma display device of claim 6, wherein the driver is further adapted to select substantially no on-cell among the plurality of second cells during the third subfield of the first frame, and to select substantially no on-cell among the plurality of first cells during the third subfield of the second frame.

8. The plasma display device of claim 6, wherein a weight of the third subfield of the first frame is the same as a weight of the third subfield of the second frame.

9. The plasma display device of claim 1, wherein the at least one on-cell sustain-discharged during the first subfield includes the at least one off-cell selected during the first address period and the at least one off-cell selected during the second address period.

10. The plasma display device of claim 1, wherein the plasma display panel further comprises a plurality of second electrodes extending in the first direction, and the plurality of second electrodes are divided into at least a first group of the second electrodes and a second group of the second electrodes,
wherein the plurality of first display regions are defined by the first group of the second electrodes, and the plurality of second display regions are defined by the second group of the second electrodes.

11. The plasma display device of claim 10, wherein the plasma display panel further comprises a plurality of third electrodes extending in the first direction,
wherein each first display region is defined by a corresponding one of the first group of the second electrodes and a corresponding one of the plurality of third electrodes, and each second display region is defined by a corresponding one of the second group of the second electrodes and a corresponding one of the plurality of third electrodes.

12. The plasma display device of claim 10, wherein the plasma display device further comprises a plurality of third electrodes extending in the first direction, and the plurality of third electrodes are divided into at least a first group of the third electrodes and a second group of the third electrodes,
wherein each first display region is defined by a corresponding one of the first group of the second electrodes and a corresponding one of the first group of the third electrodes, and each second display region is defined by a corresponding one of the second group of the second electrodes and a corresponding one of the second group of the third electrodes,
wherein the driver concurrently applies a scan pulse to one of the first group of the third electrodes and one of the second group of the third electrodes when the first and second address methods are used.

13. The plasma display device of claim 12, wherein one of the first group of the third electrodes and the second group of the third electrodes includes odd-numbered ones of the third electrodes, and the other includes even-numbered ones of the third electrodes.

14. The plasma display device of claim 10, wherein one of the first group of the second electrodes and the second group of the second electrodes includes odd-numbered ones of the second electrodes, and the other includes even-numbered ones of the second electrodes.

15. A method for driving a plasma display device, the plasma display device comprising a plurality of first electrodes extending in a first direction, a plurality of second electrodes extending in the first direction, a plurality of third electrodes extending in a second direction crossing the first direction, a plurality of first cells, and a plurality of second cells, the plasma display device being driven during frames comprising a first frame and a second frame, the method comprising:
dividing each frame into a plurality of subfields; and
in at least one subfield of the first frame:
during a first address period, selecting at least one off-cell among the plurality of first cells, by using an address method for address-discharging at least one of the cells at on-state to place the at least one of the cells at off-state;
during a first sustain period following the first address period, sustain-discharging at least one of the cells remaining at on-state after the first address period;
during a second address period following the first sustain period, selecting at least one off-cell among the plurality of second cells by using the address method; and
during a second sustain period following the second address period, sustain-discharging at least one of the cells remaining at on-state after the second address period,
wherein the plurality of second electrodes are divided into at least a first group of the second electrodes and a second group of the second electrodes,
wherein the plurality of first cells are defined by a plurality of first display regions extending in the first direction and the plurality of third electrodes, and the plurality of second cells are defined by a plurality of second display regions extending in the first direction and the plurality of third electrodes,
wherein each first display region is defined by a corresponding one of the first group of the second electrodes and a corresponding one of a plurality of scan lines, and each second display region is defined by a corresponding one of the second group of the second electrodes and a corresponding one of the plurality of scan lines, and
wherein each scan line includes corresponding at least one of the plurality of first electrodes.

16. The method of claim 15, wherein the plurality of scan lines respectively correspond to the plurality of first electrodes.

17. The method of claim 15, wherein the plurality of first electrodes are divided into at least a first group of the first electrodes and a second group of the first electrodes,
wherein each scan line corresponds to a corresponding one of the first group of the first electrodes and a corresponding one of the second group of the first electrodes,
wherein each first display region is defined by a corresponding one of the first group of the second electrodes and a corresponding one of the first group of the first electrodes, and
wherein each second display region is defined by a corresponding one of the second group of the second electrodes and a corresponding one of the second group of the first electrodes.

18. The method of claim 17, wherein one of the first group of the first electrodes and the second group of the first electrodes includes odd-numbered ones of the first electrodes, and the other includes even-numbered ones of the first electrodes.

19. The method of claim 15, wherein the selecting the at least one off-cell among the plurality of first cells comprises:
applying a first voltage to the first group of the second electrodes;
applying a second voltage lower than the first voltage to the second group of the second electrodes; and
respectively applying a first scan pulse and a first address pulse to the scan line and the third electrode of the at least one off-cell to be selected,
wherein the selecting the at least one off-cell among the plurality of second cells comprises:
applying a third voltage to the first group of the second electrodes;
applying a fourth voltage higher than the third voltage to the second group of the second electrodes; and
respectively applying a second scan pulse and a second address pulse to the scan line and the third electrode of at least one off-cell to be selected.

20. The method of claim 19, wherein the first and fourth voltages are substantially the same, and the second and third voltages are substantially the same.

21. The method of claim 19, wherein the first scan pulse has a scan voltage being substantially equal to that of the second scan pulse, and the first address pulse has an address voltage being substantially equal to that of the second address pulse.

22. The method of claim 15, further comprising
in at least one subfield of the second frame:
selecting at least one off-cell among the plurality of second cells by using the address method during a first address period;
sustain-discharging at least one of the cells remaining at on-state after the first address period during a first sustain period following the first address period;
selecting at least one off-cell among the plurality of first cells by using the address method during a second address period following the first address period; and
sustain-discharging at least one of the cells remaining at on-state after the second address period during a second sustain period following the second address period.

23. The method of claim 15, further comprising
during a third sustain period, further sustain-discharging at least one of the second cells remaining at on-state after the second address period.

24. The driving method of claim 23, wherein the further sustain discharging comprises,
during the third sustain period:
applying a first voltage to the first group of the second electrodes; and
alternately applying a second voltage higher than the first voltage and a third voltage lower than the first voltage to the plurality of scan lines and the second group of the second electrodes.

25. The method of claim 15, wherein one of the first group of the second electrodes and the second group of the second electrodes includes odd-numbered ones of the second electrodes, and the other includes even-numbered ones of the second electrodes.

26. The method of claim 15, wherein at least one of the cells remaining at on-state before the at least one subfield includes the at least one off-cell to be selected during the first address period and the at least one off-cell to be selected during the second address period.

27. A method for driving a plasma display device, the plasma display device including a plurality of first electrodes extending in a first direction, a plurality of second electrodes extending in the first direction, a plurality of third electrodes extending in a second direction crossing the first direction, a plurality of first cells, and a plurality of second cells, the plasma display device being driven during frames comprising a first frame and a second frame, the method comprising:
dividing each frame into a plurality of subfields comprising a first subfield and a second subfield; and
in the first subfield of the first frame:
during a first reset period, initializing the plurality of first cells;
during a first address period, selecting at least one first on-cell among the plurality of first cells, by using an address method for address-discharging at least one of the cells at off-state to place the at least one of the cells at on-state;
during a first sustain period, sustain-discharging the at least one first on-cell;
during a second reset period, initializing the plurality of second cells;
during a second address period, selecting at least one second on-cell among the plurality of second cells by using the address method; and
during a second sustain period, sustain-discharging the at least one second on-cell,
wherein the plurality of second electrodes are divided into at least a first group of the second electrodes and a second group of the second electrodes,
wherein the plurality of first cells are defined by a plurality of first display regions extending in the first direction and the plurality of third electrodes, and the plurality of second cells are defined by a plurality of second display regions extending in the first direction and the plurality of third electrodes,
wherein each first display region is defined by a corresponding one of the first group of the second electrodes and a corresponding one of a plurality of scan lines, and each second display region is defined by a corresponding one of the second group of the second electrodes and a corresponding one of the plurality of scan lines, and
wherein each scan line includes corresponding at least one of the plurality of first electrodes.

28. The method of claim 27, wherein the plurality of scan lines respectively correspond to the plurality of first electrodes.

29. The method of claim 27, wherein the plurality of first electrodes are divided into at least a first group of the first electrodes and a second group of the first electrodes,
wherein each scan line corresponds to a corresponding one of the first group of the first electrodes and a corresponding one of the second group of the first electrodes,
wherein each first display region is defined by a corresponding one of the first group of the second electrodes and a corresponding one of the first group of the first electrodes, and
wherein each second display region is defined by a corresponding one of the second group of the second electrodes and a corresponding one of the second group of the first electrodes.

30. The method of claim 29, wherein the selecting the at least one first on-cell comprises:
applying a first voltage to the first group of the second electrodes;
applying a second voltage lower than the first voltage to the second group of the second electrodes; and
respectively applying a first scan pulse and a first address pulse to the scan line and the third electrode of the at least one first on-cell, and
wherein the selecting the at least one second on-cell comprises:
applying a third voltage to the first group of the second electrodes;
applying a fourth voltage higher than the third voltage to the second group of the second electrodes; and
respectively applying a second scan pulse and a second address pulse to the scan line and the third electrode of the at least one second on-cell.

31. The method of claim 30, further comprising, during a period between the second reset period and the second address period, further sustain-discharging the at least one first on-cell.

32. The method of claim 31, wherein the further sustain-discharging the at least one first on-cell comprises:
applying a first voltage to the plurality of scan lines; and
applying a second voltage higher than a first voltage to the first group of the second electrodes and the second group of the second electrodes, and
wherein the selecting the at least one second on-cell comprises:
applying the second voltage to the first group of the second electrodes and the second group of the second electrodes; and
respectively applying scan and address pulses to the scan line and the third electrode of the at least one second on-cell.

33. The method of claim 27, wherein
during the first reset period, at least one of the first cells remaining at on-state before the first subfield is reset-discharged to initialize the plurality of first cells; and
during the second reset period, the plurality of second cells are reset-discharged to initialize the plurality of second cells.

34. The method of claim 27, wherein the initializing the plurality of first cells comprises gradually decreasing a voltage at the plurality of scan lines while applying a first voltage to the first group of the second electrodes, and applying a second voltage lower than the first voltage to the second group of the second electrodes, and
wherein the initializing the plurality of second cells comprises:
gradually increasing the voltage at the plurality of scan lines while applying a third voltage to the first group of the second electrodes, and applying a fourth voltage lower than the third voltage to the second group of the second electrodes; and
gradually decreasing the voltage at the plurality of scan lines while applying a fifth voltage to the first group of the second electrodes, and applying a sixth voltage higher than the fifth voltage to the second group of the second electrodes.

35. The method of claim 27, further comprising further sustain-discharging the at least one first on-cell during the second sustain period.

36. The method of claim 27, further comprising,
in the first subfield of the second frame:
during a first reset period, initializing the plurality of second cells;
during a first address period, selecting at least one third on-cell among the plurality of second cells by using the first address method;
during a first sustain period, sustain-discharging the at least one third on-cell;
during a second reset period, initializing the plurality of first cells;
during a second address period, selecting at least one fourth on-cell among the plurality of first cells by using the first address method; and
during a second sustain period, sustain-discharging the at least one fourth on-cell.

37. The method of claim 36, further comprising:
in the second subfield of the first frame:
selecting at least one fifth on-cell among the plurality of first cells by using the first address method;
sustain-discharging the at least one fifth on-cell;
not selecting substantially any on-cell among the plurality of second cells; and
in the second subfield of the second frame:
selecting at least one sixth on-cell among the plurality of second cells by using the first address method;
sustain-discharging the at least sixth on-cell; and
selecting substantially no on-cell among the plurality of first cells,
wherein the second subfield is previous to the first subfield.

38. The method of claim 27, further comprising,
in the second subfield of the first frame:
selecting at least one off-cell among the plurality of first cells by using a second address method for address-discharging at least one of the cells at on-state to place the at least one of the cells at off-state, during a first address period;
sustain discharging at least one of the cells remaining at on-state after the first address period, during a first sustain period;
selecting at least one off-cell among the plurality of second cells by using the second address method, during a second address period; and
sustain-discharging at least one of the cells remaining at on-state after the second address period, during a second sustain period.

39. A method for driving a plasma display device, the plasma display device including a plurality of first electrodes, a plurality of second electrodes, a plurality of third electrodes crossing the plurality of first and second electrodes, the plasma display device being driven during frames comprising a first frame and a second frame, the method comprising:
dividing each frame into a plurality of subfields;
in at least one subfield of the first frame:
during a reset period, initializing a plurality of first cells;
during an address period, selecting at least one first on-cell among the plurality of first cells; and
during a sustain period, sustain-discharging the at least one first on-cell;
in at least one subfield of the second frame:
during a reset period, initializing a plurality of second cells;
during an address period, selecting at least one second on-cell among the plurality of second cells; and
during a sustain period, sustain-discharging the at least one second on-cell,
wherein the plurality of second electrodes are divided into at least a first group of the second electrodes and a second group of the second electrodes,
wherein the plurality of first cells are defined by a plurality of first display regions and the plurality of address electrodes, and the plurality of second cells are defined by a plurality of second display regions and the plurality of address electrodes,
wherein each first display region is defined by a corresponding one of the first group of the second electrodes and a corresponding one of a plurality of scan lines, and each second display region is defined by a corresponding one of the second group of the second electrodes and a corresponding one of the plurality of scan lines, and
wherein each scan line includes corresponding at least one of the plurality of first electrodes.

40. The method of claim 39, further comprising:
selecting substantially no on-cell among the plurality of second cells during the at least one subfield of the first frame; and
selecting substantially no on-cell among the plurality of first cells during the at least one subfield of the second frame.

41. The method of claim 39, wherein light is substantially not emitted from the plurality of second cells during the at least one subfield of the first frame, and
light is substantially not emitted from the plurality of first cells during the at least one subfield of the second frame.
